(19) United States
(12) Patent Application Publication
(10) Pub. No.: US 2012/0130892 A1
(43) Pub. Date: May 24, 2012

(54) TOY WITH INDICIA OF STORED VALUE

(76) Inventor: Robin Ronayne, Rosemount, MN (US)

(21) Appl. No.: 12/953,526

(22) Filed: Nov. 24, 2010

(51) Int. Cl. G06Q 40/00; G06K 19/077; G06K 19/06; G06K 19/00

(52) U.S. Cl. 705/41; 235/487; 235/492; 235/493; 235/494

(57) ABSTRACT

The present invention is a stored value toy, and a method for sensing a stored value toy. A stored value toy integrates the functionality of a stored value card, or a gift card, into a three-dimensional toy, such as a model vehicle. The method includes sensing an account identifier from an account indicium permanently coupled in the toy, associating the identifier with an account, and taking some action involving the account. The action might be reading the account balance, initializing the balance with an amount, increasing the balance, or decreasing the balance.

### FIELD OF THE INVENTION

The present invention relates to stored value media. More specifically, it relates to a three-dimensional toy to which indicia of stored value are permanently coupled.

### BACKGROUND OF THE INVENTION

A stored value card is a card that represents some kind of value, typically financial value. For example, a stored value card might be redeemable at a particular store for a certain monetary value in merchandise or services. A stored value card might simply represent an amount of cash, which might be used, for example, as a substitute for a credit or debit card in making any kind of purchase, or to pay off debt. A stored value card might be restricted to a particular set of products or services; for example, it might represent ten deluxe car washes at some gas station. A gift card is a particular kind of stored value card, one purchased by a donor as a gift for, e.g., a friend, a relative, or an employee.

A stored value card must typically be activated before it can be used to spend a portion of its stored value. This requirement protects the card retailer by reducing both the likelihood and the consequences of theft while the cards are displayed, and accessible to the public, in a store. The card is activated by an initial scanning at the point of sale at the time when it is purchased, and, at the same time, an initial amount is associated with the card.

The initially added funds give the stored value card an initial value balance. The stored value represented by the card is reduced when the card is used to make a purchase. Additional value for the card can typically be purchased from the card issuer or a card seller. In the case of a gift card, the donee or the donor might be able to buy additional stored value.

The balance of value remaining on the stored value card may be stored as an account in an electronic recordkeeping system, or database. In this case, the card must contain a device that provides identifying indicia for the account, such as a bar or UPC code, a magnetic strip, a radio frequency identification (RFID) tag, a smart chip, or other identifying device. In the case of a card with a smart chip or other device where the card itself contains logic in the form of hardware (including possibly a processor) and/or software instructions, the stored value balance may be maintained within the card itself. When a stored value card is redeemed, for example to make a purchase, then the account balance is reduced by the purchase amount. At a retail establishment, the account balance is usually automatically adjusted at the point of sale by the action of scanning the card, or manually by salesperson data entry.

### SUMMARY OF THE INVENTION

The inventors realized that alternatives to traditional plastic cards might be more marketable to some audiences. If the recipient of a gift card is a child, for example, the card itself and even the stored value it represents may be meaningless. A toy vehicle, on the other hand, would be pleasing to many children. A toy car might also be interesting to an adult, for example, if the toy modeled the adult's real automobile.

Account indicia may be permanently coupled to, or integrated into, a toy vehicle, thereby combining the attractiveness of the toy with all the advantages of a stored value card. We will refer to a toy, such as a toy vehicle, that having integrated stored value functionality as a “stored value toy”. In general, a stored value toy can have all the capabilities and features of the toy itself. But like a stored value card, a stored value toy will include some kind of account indicia, such as a magnetic strip or a bar code, and may also include a human readable number and a Product Identification Number (PIN).

Identifying indicia for the account may be permanently coupled directly to the toy, for example on an external surface. When we say that an account indicium is “permanently coupled” to a toy, we mean that the toy is designed to make it difficult for a user to remove the account indicium. For example, the indicium might be printed or painted directly onto the toy. The account indicia might be printed on a plastic or metal plaque. Such plaque or other object containing a surface into which the indicia is printed, embedded, or integrated, might be permanently coupled by glue, by welding, by screws or bolts, or by stitching with thread or other fiber, depending on the type of toy.

For example, if the toy is a toy vehicle made primarily from metal or wood, then any of the above attachment methods except stitching might be used to attach the account indicia to the toy itself. In some embodiments, the account indicia might be recessed to protect expression of the indicia from being degraded by friction or other contact with external objects. For example, if the account indicia are printed on or otherwise attached to the underbody surface of a toy car, then the wheels of the vehicle will help to prevent contact of the account indicia with a surface upon which vehicle rests or rolls. The account indicia may be attached to a surface of the toy that may be smooth, and may be essentially flat.

If the toy is a doll, a stuffed figure, or other toy having fabric outer surfaces, the account indicia may be attached to the toy or to clothing worn by the toy, and the surface to which it is coupled might be substantially curved, and/or rough. Such attachment might be done by printing or by a fabric panel stitched to the fabric.

In principle, like any toy generally, a stored value toy might come in any size and shape. A toy within the scope of the invention, however, will preferably be three-dimensional. By that we mean that it is not essentially two-dimensional. A toy that is printed on a sheet of cardboard, paper, or steel would be essentially two dimensional. A toy vehicle, such as a MATCHBOX® car sold by Mattel, Inc., is an example of a toy that is three-dimensional, not essentially two-dimensional. A stuffed figure is another example of a three-dimensional toy.

A logo or contact information on a stored value toy could be a useful advertising tool. Such a toy might be given to employees, with a bonus in the stored value. A firm wishing to market itself could send a stored value toy to prospective clients. A retailer could give a reward to loyal customers in a stored value toy, or use a stored value toy as incentive for customers to make a particular purchase, or simply to attract customers to a store or website.

Embodiments of the invention include a method, comprising the steps of: during a transaction, sensing electronically an account indicium permanently coupled to a stored value toy; using a processing system, associating the account indicium with information, stored in tangible electronic storage, regarding an account; and reading a stored value balance of the account, or, in an amount corresponding to the transaction, initializing, raising, or lowering the stored value balance.

Embodiments of the invention include an account maintenance system, comprising: a set of software instructions stored in tangible storage; a stored value balance, stored in tangible storage, the stored value balance identified by an account identifier; and processing hardware that (i) receives a transaction request and the account identifier through a communication system, the account identifier having been obtained by accessing account indicia permanently coupled to a stored value toy, (ii) retrieves and executes the software instructions, and (iii) updates the stored value balance identified by the account identifier consistently with the transaction request.

### BRIEF DESCRIPTION OF THE DRAWINGS

FIG. 1 is a side view of an exemplary stored value toy, a car.

FIG. 2 is a bottom view of the stored value toy of the previous figure, including integrated account indicia.

FIG. 3 is a front view of an exemplary stored value toy, a robot that shows integrated account indicia and an advertisement.

FIG. 4 is a top view of the stored value toy of the previous figure.

FIG. 5 is a schematic showing an exemplary account maintenance system for maintaining a stored value balance associated with a stored value toy.

FIG. 6 is a flow chart showing an exemplary process for accessing the stored value represented by a stored value toy in a transaction.

### DETAILED DESCRIPTION OF EXEMPLARY EMBODIMENTS

Illustrative embodiments of the invention are described by the drawings and the accompanying text below. A person having skill in the art will recognize that many other embodiments and variations are possible within the scope of the invention that permanently couples indicia of stored value into a three-dimensional toy, such as a model car.

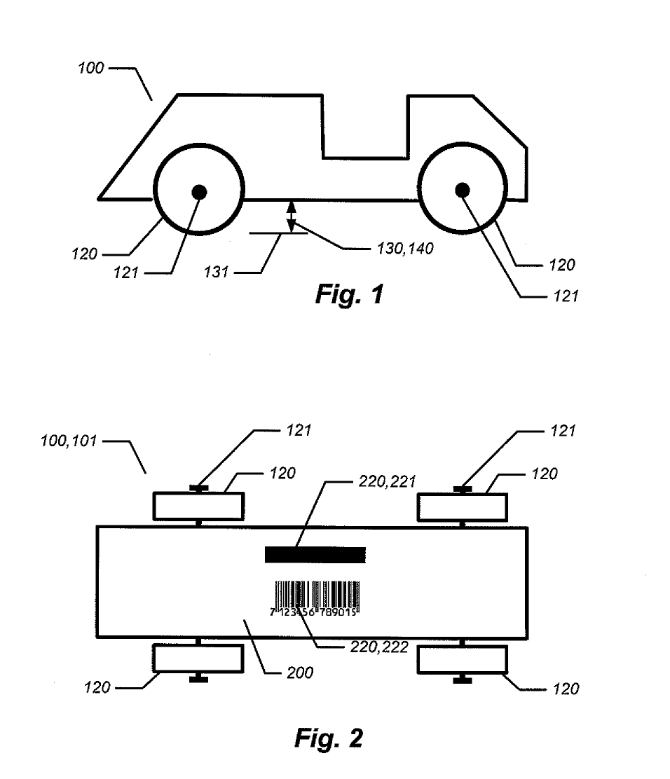

FIGS. 1 and 2 are left side and bottom views of an embodiment of a stored value toy 100, in this case a toy car 101. This car 101 can be rolled across a surface, such as a table, on four wheels 120. Front and rear pairs of wheels 120 are attached to the ends of respective axles 121. The wheels 120 and axles 121 support the body of the car 101 at some elevation distance 130 away from ground level 131, where by ground level 131 here we mean, for example, a table top on which the car 101 is being used.

The bottom of the car 101, illustrated by FIG. 2, shows two different account indicia 220, in this case an RFID tag 221 and a bar code 222. A magnetic stripe or other form of account indicium 220 might also be used. Having account indicia 220 of a plurality of types may have the advantage of making the stored value toy 100 capable of being scanned by more sensor types or point of sale (POS) systems. In the embodiment shown, the bar code 222 might be printed or painted onto the bottom of the car, while the RFID tag 221 might be on, or inside, a rectangular metal or plastic strip, that might be attached to the bottom of the car with, for example, glue or screws.

An account indicium 220 might be recessed to prevent contact that might damage or inadvertently remove the account indicium 220 from the toy 100. In the case of the car 101 shown in FIGS. 1 and 2, the elevation distance 130 from the wheels 120 and axles 121, in effect, provides such a recess 140.

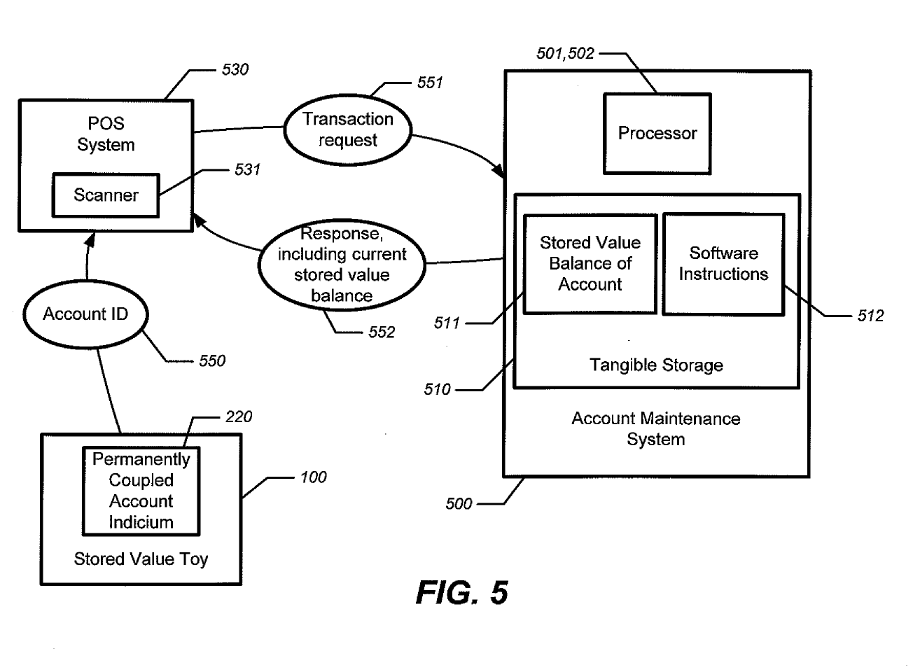

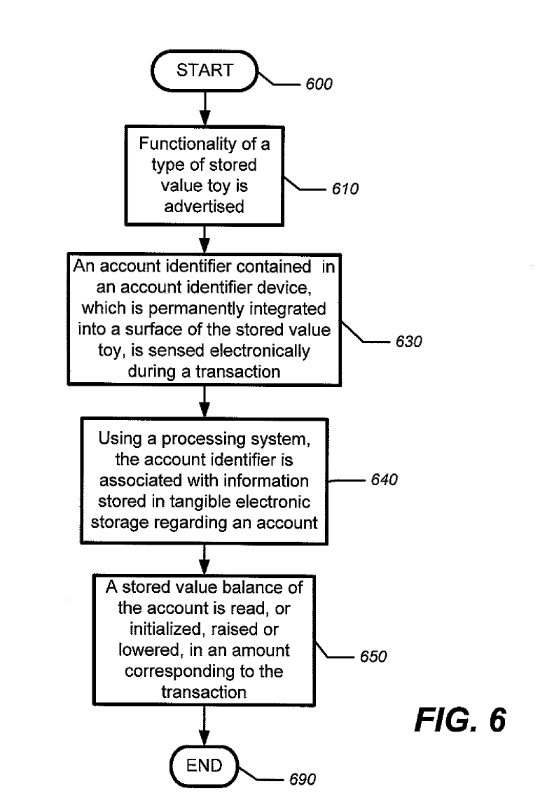

An account indicium 220 associates the stored value toy 100 with a particular account identifier 550, which identifies a unique account. Account information may be maintained in an account maintenance system 500, as later described in connection with FIGS. 5 and 6.

The account indicia 220 allow the toy 100 to be scanned, the scanning possibly accomplishing several purposes. An initial scan by a POS system of the stored value toy 100 may establish an initial balance. A particular stored value toy 100 might have a fixed initial balance, or the user (e.g., a donor or donee) might be free to specify and purchase an initial balance, which might be entered by a salesperson at POS into the account maintenance system 500. The initial scan might also activate the account, so that the account maintenance system 500 will allow future purchases of goods or services or other expenditures to be made against the stored value. The initial scan might also update inventory data pertaining to this or similar stored value toys 100, and update transactional data pertaining to the purchase and activation. Subsequent scans can be used to reduce the stored value to make purchases or expenditures. In some embodiments, additional stored value can purchased, which typically would also involve scanning the stored value toy 100.

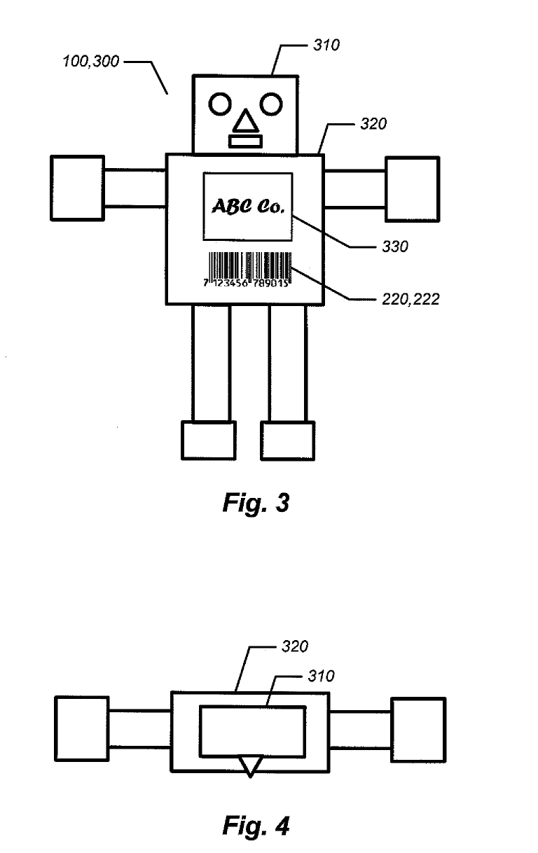

FIGS. 3 and 4 illustrate another exemplary stored value toy 100, in this case a robot 300. The robot 300 has account indicia 220, a bar code 222. FIG. 4 implies that the robot 300 is not essentially flat, but is three-dimensional.

In some circumstances, a person or entity might want to give a stored value toy 100 as a form of advertising, for example: as a reward to loyal customers; as a way of increasing awareness of a company's name and contact information to clients or client prospects; or as an incentive to visit a store, or to purchase a particular item. In such cases, the toy 100 might display a company logo or icon, such as the advertising material 330 shown in FIG. 3. Other characteristics of the toy 100 might also serve to promote a brand. For example, the toy 100 in FIG. 3 might be colored yellow, in accord with trademarks of BBY Solutions, Inc. Thus, the color might call a trademarked symbol to mind for some observers of the toy 100.

FIG. 5 is a schematic showing an exemplary account maintenance system 500 for maintaining a stored value balance associated with a stored value toy 100. The account maintenance system 500 includes processing hardware 501 that executes logic. The processing hardware 501 might include a hardware processor 502, such as the kind of processor that might be included in a computer or a smart cell phone. Some or all of the functionality of the account maintenance system 500 might be performed by the stored value toy 100 itself, through a smart chip or an internal processing system.

A smart chip, such as an RFID tag 221, might draw power from a battery or external source. Preferably, it will contain a logic in the form of hardware/and or software instructions, that would draw power from a scanner or reader device, so that account information and stored value balance might be changed within the stored value toy 100 itself.

The account maintenance system 500 might be a processing system—by a “processing system” we mean one or more devices having processors, such as computers, possibly communicating over one or more networks or any other electronic communications systems, and utilizing one or more storage devices and peripheral devices, possibly under the management of one or more persons or entities, and controlled by various logical units such as hardware and software programs. The logic might be wholly or partially in the form of software instructions 512, which might be stored in some form of tangible storage 510, and retrieved by the processing hardware 501 as needed. The tangible storage 510 might be a hard drive, an optical disk, a memory card, or any other volatile or non-volatile hardware device that can retain information in electronic form.

A stored value balance 511 associated with the stored value toy 100 will also be stored in tangible storage 510, which might be within the same device or a different device from the device(s) containing the software instructions 512. The stored value balance 511 might be stored in a database, file, or any other information storage representations. If the stored value balance 511 is maintained in a database, an account identifier 550 might be used to associate the correct stored value balance 511 with this particular stored value toy 100.

In the example shown in FIG. 5, a POS system 530 includes a scanner 531. A transaction (e.g., report account balance; purchase an item; increase account balance) involving the stored value toy 100 can be performed by scanning the account indicium 220 that is permanently coupled to the stored value toy 100. In this example, an account identifier 550 is read by the scanner 531 and provided to the POS system 530. The POS system 530 transmits a transaction request 551 for the appropriate transaction, along with the account identifier 550 to the account maintenance system 500. The account maintenance system 500 handles the transaction by executing software instructions 512 on the processor 502, which accesses the stored value balance 511, and modifies the balance accordingly if necessary. A transaction response 552 is then returned by the account maintenance system 500 to the POS system 530, showing the current, possibly updated, stored value balance 511.

FIG. 6 is a flowchart illustrating an embodiment of the invention. After the start 600, some functionality of a type of stored value toy 100 is advertised 610. The “type” might be, for example, a particular manufacturer, vendor, brand, model, or SKU of the stored value toy 100. The functionality might be any feature of the stored value toy 100, such as the combination of a toy car 101 and stored value capability. As described previously, a stored value toy 100 integrates stored value functionality into a toy 100. The advertising might be by any method employed by a seller of the type of stored value toy 100; for example, a newspaper advertisement; online publication of products and their capabilities; an in-store display of a stored value toy 100 for sale; or a demonstration by a salesperson of a stored value toy 100 to a customer. Note that some embodiments of the methods of the invention do not include this advertising step.

An account identifier 550 contained in account indicia 220, printed on, or otherwise permanently integrated into, the surface of the stored value toy 100, is sensed 630 electronically during a transaction. For example, the transaction might be to read the stored value balance associated with the stored value toy 100; initialization or activation of the stored value in the stored value toy 100; purchase of the stored value toy 100; purchase of goods or services, or payment of debt, using the stored value toy 100; other expenditure of value from the stored value toy 100; increase in the stored value of the stored value toy 100; or any other transaction involving scanning the stored value toy 100. Sensing might involve any kind of equipment, such as a hand-held device or a POS scanner. Sensing might use any technology, such as radio frequencies, laser, charge-coupled device (CCD) technology, Contact Image Sensor (CIS) technology, photomultiplier tube technology, photographic scanning, or 3D scanning technology. Sensing might be performed actively by a person, or passively by an automated sensing device such as an RFID sensor. The person might be anyone, such as an employee of a store that is selling the stored value toy 100, applying the stored value to a purchase, or adding stored value to the stored value toy 100; it might be a stored value toy 100 purchaser, giver, recipient, or owner. The account identifier 550 will usually be a sequence of letters and/or numerals, but it could be any combination of symbols that might uniquely identify an account. The account indicium 220 might be a magnetic strip, a bar code 222, a smart chip, a RFID tag 221, or any other type of device from which a sensor might sense or read an account identifier 550. “Electronically” merely implies that some aspect of the sensing involves electricity.

Using a processing system (defined broadly, as described previously), the account identifier is associated 640 with information stored in tangible electronic storage regarding an account. Note that the account may not exist in the storage prior to the transaction. For example, upon activation of a stored value toy 100, data regarding an account may be initialized within the storage 510, but association will be performed nevertheless between the account indicium 220 and the new account. A stored value balance 511 of the account is read from storage 510, or, in an amount corresponding to the transaction, initialized, raised, or lowered 650. For example, the stored value balance 511 might be initialized at when a donor purchases a stored value toy 100 as a gift and the stored value toy 100 is activated. The stored value balance 511 might be lowered when a recipient of a gift stored value toy 100 uses the stored value toy 100 to make a purchase. The stored value balance 511 might be increased upon activation, if the account already exists in storage 510 with a zero balance. This might also be regarded as initialization of the stored value balance 511. The stored value balance 511 might also be increased, for example, by a recipient of a gift stored value toy 100 (or by the original giver or anyone else) by a purchase of additional stored value. The process ends 660. In other embodiments, the stored value balance 511 is retrieved upon sensing.

Of course, many variations of the above embodiments are possible within the scope of the invention. The present invention is, therefore, not limited to all the above details, as modifications and variations may be made without departing from the intent or scope of the invention. Consequently, the invention should be limited only by the following claims and equivalent constructions.

What is claimed is:

1. An apparatus, comprising:
a) a toy vehicle; and
b) an account indicium, permanently coupled to the toy vehicle, that associates the toy vehicle with a stored value account.

2. The apparatus of claim 1, wherein the account indicium is printed on the toy vehicle.

3. The apparatus of claim 1, wherein the account indicium is painted on the toy vehicle.

4. The apparatus of claim 1, wherein the account indicium is rigidly integrated into the toy vehicle.

5. The apparatus of claim 1, wherein the account indicium is included on an insert that is rigidly integrated into the toy vehicle.

6. The apparatus of claim 5, wherein the insert is glued, bolted, or screwed to the toy vehicle.

7. The apparatus of claim 1, wherein the account indicium is an RFID tag, a bar code, or a magnetic strip.

8. The apparatus of claim 1, further comprising:
c) tangible storage wherein an account balance that corresponds to the account indicium is maintained.

9. The apparatus of claim 1, further comprising:
c) hardware, which participates in the execution of logic that calculates an account balance corresponding to the account indicium.

10. The apparatus of claim 1, wherein the account indicium is of a first type, and further comprising:
c) a second account indicium, of a type different from the first type.

11. The apparatus of claim 1, further comprising:
c) space on a surface that displays advertising information.

12. The apparatus of claim 11, wherein the advertising information is in accord with a brand trademark.

13. The apparatus of claim 11, wherein the advertising information includes an aspect of color or shape of the toy vehicle.

14. A method, comprising:
a) during a transaction, sensing electronically an account identifier from an account indicium permanently coupled to a stored value toy;
b) using a computer system, associating the account identifier with information, stored in tangible electronic storage, regarding an account; and
c) reading a stored value balance of the account, or, in an amount corresponding to the transaction, initializing, raising, or lowering the stored value balance.

15. An apparatus, comprising:
a) a three-dimensional toy; and
b) an account indicium, permanently coupled to the toy, that associates the toy with a stored value account.

16. The apparatus of claim 15, wherein the toy is a doll or stuffed animal.

17. The apparatus of claim 15, wherein the account indicium is included in a panel that is stitched or sewn onto the toy.

18. An account maintenance system, comprising:
a) a set of software instructions stored in tangible storage;
b) a stored value balance, stored in tangible storage, the stored value balance identified by an account identifier; and
c) processing hardware that
(i) receives a transaction request and the account identifier through a communication system, the account identifier having been obtained by accessing account indicia permanently coupled to a stored value toy,
(ii) retrieves and executes the software instructions, and
(iii) updates the stored value balance identified by the account identifier consistently with the transaction request.
